(19) United States
(12) Patent Application Publication
(10) Pub. No.: US 2026/0077747 A1
(43) Pub. Date: Mar. 19, 2026

(54) System and Method for Control of Service Braking in a Trailer of a Combination Vehicle

(71) Applicant: KB Intellectual Property GmbH &Co. KG, Pullach (DE)

(72) Inventors: Jeffrey M. Carbaugh, Lakewood, OH (US); Andrew J. Pilkington, Avon Lake, OH (US)

(21) Appl. No.: 18/890,138

(22) Filed: Sep. 19, 2024

(51) Int. Cl. B60T 8/17; B60T 7/12; B60T 13/68

(52) U.S. Cl. CPC B60T 8/1708; B60T 7/12; B60T 13/683; B60T 2201/03

(57) ABSTRACT

A system for controlling service braking in a trailer of a combination vehicle includes an electropneumatic valve module having a supply port in fluid communication with a fluid source and a delivery port configured to deliver a control pressure to the trailer for actuating a service brake on the trailer. A brake controller receives a handshake signal from an advanced drive assistance system (ADAS) controller on the vehicle and determines, responsive to the handshake signal, whether the brake controller will operate in a basic or enhanced mode. Upon receipt of a brake request signal from the ADAS controller, the brake controller transmits a first or a second control signal to the valve assembly, depending on whether the brake controller is operating in the basic or enhanced mode, causing the valve assembly to deliver the control pressure with a first characteristic or a second characteristic, different from the first characteristic.

### BACKGROUND OF THE INVENTION

### a. Field of the Invention

This disclosure relates to a system and method for controlling service braking in a trailer of a combination vehicle. In particular, this disclosure relates to a system and method that allow variation in service braking pressure on the trailer responsive to the identity of the vehicle system requesting service braking.

### b. Background Art

In a combination vehicle, the towing unit, or tractor, actuates service brakes on a towed unit, or trailer, by transmitting a control pressure from the tractor to the trailer. The control pressure actuates one or more valves on the trailer to deliver fluid pressure from a fluid source on the trailer to brake actuators for one or more wheel brakes on the trailer. The fluid pressure delivered to the brake actuators on the trailer is proportional to the control pressure received from the tractor. Although conventional trailers often include anti-lock braking systems (ABS), the state or health of the trailer ABS system is often unknown to elements of the braking system on the tractor. As a result, the control pressure from the tractor is often pulsed, or modulated, to prevent the trailer brakes from locking up. In situations where the trailer lacks an ABS system or the ABS system on the trailer is not functioning properly, this action allows safer operation of the vehicle. In situations where the trailer includes a properly functioning ABS system, however, this action unduly limits the potential braking torque generated by the trailer wheel brakes and increases the stopping distance of the vehicle.

The inventors herein have recognized a need for a system and method for controlling service braking in a trailer of a combination vehicle that will minimize and/or eliminate one or more of the above-identified deficiencies.

### BRIEF SUMMARY OF THE INVENTION

This disclosure relates to a system and method for controlling service braking in a trailer of a combination vehicle. In particular, this disclosure relates to a system and method that allow variation in service braking pressure on the trailer responsive to the identity of the vehicle system requesting service braking.

An embodiment of a system for controlling service braking in a trailer of a combination vehicle includes an electropneumatic valve module having a supply port in fluid communication with a fluid source and a delivery port configured to deliver a control pressure to the trailer for actuating a service brake on the trailer. The system further includes a brake controller configured to operate in a basic mode and an enhanced mode. The brake controller is configured to receive a handshake signal from an advance driver assistance system (ADAS) controller on the combination vehicle and determine, responsive to the handshake signal, whether the brake controller will operate in the basic mode or the enhanced mode. The brake controller is further configured to receive a brake request signal from the ADAS controller. The brake controller is further configured to transmit, if the brake controller is operating in the basic mode, a first control signal to the electropneumatic valve module in response to the brake request signal. The first control signal is configured cause the electropneumatic valve module to deliver the control pressure with a first characteristic. The brake controller is further configured to transmit, if the brake controller is operating in the enhanced mode, a second control signal to the electropneumatic valve module in response to the brake request signal. The second control signal is configured to cause the electropneumatic valve module to deliver the control pressure with a second characteristic different than the first characteristic.

An embodiment of an article of manufacture includes a non-transitory computer storage medium having a computer program encoded thereon that, when executed by a brake controller for a braking system of a combination vehicle, controls service braking in a trailer of the combination vehicle. The vehicle includes an electropneumatic valve module having a supply port in fluid communication with a fluid source and a delivery port configured to deliver a control pressure to the trailer for actuating a service brake on the trailer. The brake controller is configured to operate in a basic mode and an enhanced mode. The computer program include code for determining, responsive to a handshake signal received by the brake controller from an advance driver assistance system (ADAS) controller on the combination vehicle, whether the brake controller will operate in the basic mode or the enhanced mode. The computer program further includes code for recognizing a brake request signal received by the brake controller from the ADAS controller. The computer program further includes code for causing the brake controller to transmit, if the brake controller is operating in the basic mode, a first control signal to the electropneumatic valve module in response to the brake request signal. The first control signal is configured cause the electropneumatic valve module to deliver the control pressure with a first characteristic. The computer program further includes code for causing the brake controller to transmit, if the brake controller is operating in the enhanced mode, a second control signal to the electropneumatic valve module in response to the brake request signal. The second control signal is configured to cause the electropneumatic valve module to deliver the control pressure with a second characteristic different than the first characteristic.

An embodiment of a method for controlling service braking in a trailer of a combination vehicle, the vehicle including an electropneumatic valve module having a supply port in fluid communication with a fluid source and a delivery port configured to deliver a control pressure to the trailer for actuating a service brake on the trailer, includes receiving, at a brake controller on the combination vehicle, a handshake signal from an advance driver assistance system (ADAS) controller on the combination vehicle. The method further includes determining, responsive to the handshake signal, whether the brake controller will operate in a basic mode or an enhanced mode. The method further includes receiving, at the brake controller, a brake request signal from the ADAS controller. The method further includes transmitting, if the brake controller is operating in the basic mode, a first control signal to the electropneumatic valve module in response to the brake request signal. The first control signal is configured to cause the electropneumatic valve module to deliver the control pressure with a first characteristic. The method further includes transmitting, if the brake controller is operating in the enhanced mode, a second control signal to the electropneumatic valve module in response to the brake request signal. The second control signal is configured to cause the electropneumatic valve module to deliver the control pressure with a second characteristic different than the first characteristic.

A system and method for controlling service braking in a trailer of a combination vehicle in accordance with the teachings disclosed herein is advantageous relative to conventional systems and methods. In particular, the disclosed systems and method allow variation in the control pressure used for trailer service braking based on the identity of the system requesting actuation of the service brakes thereby allowing selective delivery of greater control pressures and, as a result, increased service braking torque from the trailer service brakes and a reduction in the stopping distance for the vehicle.

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic view of a combination vehicle.

FIG. 2 is diagrammatic view of a brake control system for the combination vehicle of FIG. 1 including a system for controlling service braking in a trailer of the combination vehicle in accordance with the teachings set forth herein.

FIG. 3 is a flow chart diagram illustrating several steps in one embodiment of a method for controlling service braking in a trailer of the combination vehicle in accordance with the teachings set forth herein.

### DETAILED DESCRIPTION OF THE INVENTION

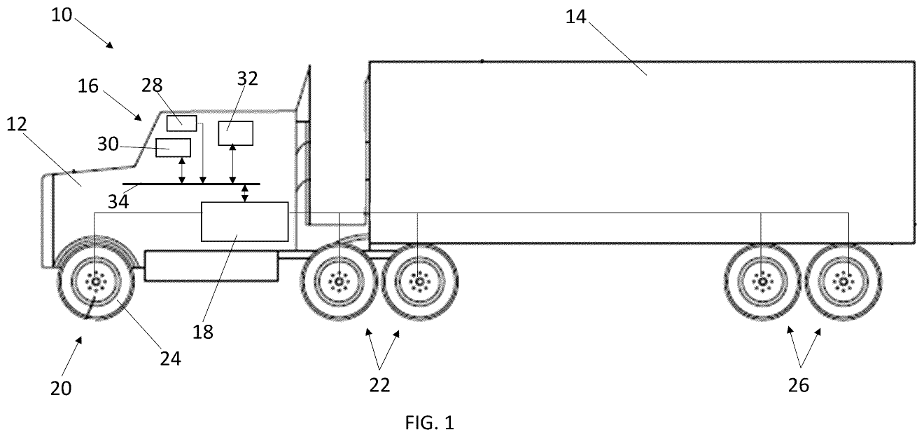

Referring now to the drawings wherein like reference numerals are used to identify identical components in the various views, FIG. 1 illustrate a combination vehicle 10. In the illustrated embodiment, vehicle 10 comprises a commercial vehicle and, in particular, a tractor-trailer. It should be understood, however, that the systems and methods disclosed herein may find application on other types of commercial and non-commercial combination vehicles. Vehicle 10 includes a towing member or tractor 12 and a towed member or trailer 14. Vehicle 10 further includes one or more advanced driver assistance systems (ADAS) 16 and a brake control system 18.

Tractor 12 provides power for moving trailer 14. Tractor 12 includes steering and drive axles 20, 22 each of which support one or more wheels 24 at either end. Tractor 12 further includes a power unit, such as an internal combustion engine or electric motor for generating mechanical energy used to rotate the wheels and a battery that provides electrical energy for use in starting the power unit and, in embodiments where the power unit includes an electric motor, for use by the power unit in generating the mechanical energy used to drive the wheels. The battery may also provide power to various accessory systems on vehicle 10.

Trailer 14 is provided to carry or store freight and is detachably coupled to tractor 12. Although a single trailer 14 is shown in the illustrated embodiment, it should be understood that the number of trailers attached to tractor 12 may vary. Trailer 14 is supported on one or more trailer axles 26, each of which may support one or more wheels 24 at either end.

ADAS systems 16 are provided to assist the operator of vehicle 10 by providing information (e.g., warnings) to the operator and/or assuming control of, or supplementing operator control of, various vehicle systems. ADAS systems 16 may, for example, include forward collision warning systems, blind-spot warning systems, lane departure warning systems, cross traffic warning systems, automated emergency braking (AEB) systems, anti-lock braking (ABS) systems, collision avoidance systems, adaptive cruise control systems, traction control systems, stability control systems, lane keep assist systems or lane centering systems and parking assist systems. An ADAS system 16 may include one or more sensors 28, an operator interface 30 and a controller 32. Sensors 28, operator interface 30 and controller 32 may communicate with one another through direct electrical connections or over a conventional vehicle communications bus 34 implementing a communications network such as a controller area network (CAN) or local interconnect network (LIN) or over a vehicle power line through power line communication (PLC) in accordance with various industry standard protocols including by not limited to SAE J1939, SAEJ1922, and SAE J2497 or using a proprietary protocol.

Sensors 28 are provided to identify various conditions associated with vehicle 10 and the surrounding environment including conditions that may impact the operation of vehicle 10. Sensors 28 may, for example, include speed sensors configured to determine the rotational speed of a component of vehicle 10 such as a wheel (i.e., a wheel speed sensor) or a power transmission shaft. Sensors 28 may include pressure sensors configured to determine atmospheric pressure or the pressure in a component of vehicle 10 such as tire, a brake actuator chamber, a compressor, or a conduit of a fluid circuit that delivers fluid to, or exhausts fluid from, another component of vehicle 10. Sensors 28 may include position sensors configured to determine a degree of rotation of a component of vehicle 10 such as a steering column component indicative of the steer angle for vehicle 10 (i.e., a steer angle sensor) or to determine the state or position of a component of vehicle 10 such as a brake pedal or door. Sensors 28 may include temperature sensors configured to determine ambient temperature in the area in which vehicle 10 is located or a localized temperature within vehicle 10. Sensors 28 may include moisture sensors configured to determine humidity. Sensors 28 may include altimeters configured to determine the altitude of vehicle 10 or the change in grade of the surface on which vehicle 10 is travelling. Sensors 28 may include GPS sensors or yaw rate sensors configured to determine the direction of travel of vehicle 10. Sensors 28 may include radar (radio detection and ranging) sensors, lidar (light detection and ranging) sensors, or cameras configured to output signals indicative of the presence of objects (e.g., other vehicles, pedestrians or road infrastructure) within a defined field of view and to provide information regarding the objects including, for example, the presence of the object within the field of view, the position or location of the object within the field of view and the distance between the object and vehicle 10. Sensors 28 may also include voltage or current sensors configured to measure the voltage or current level in component of vehicle 10. It should be understood that this listing of types of sensors 28 and the operating conditions measured or sensed by the sensors 28 is not meant to be exhaustive and that other types of sensors 28 could be employed for use within ADAS system 16.

Operator interface 30 provides an interface between the vehicle operator and ADAS system 16 through which the operator can control certain vehicle functions and receive information about the operation of vehicle 10. Interface 30 may be mounted within the cabin of vehicle 10 and, in particular, on the dashboard of vehicle 10. Interface 30 may assume various forms. Interface 30 may, for example, include a touch screen display with a graphical user interface (GUI). Interface 30 may include one or more handles, push buttons or switches through which an operator may input commands to vehicle 10. Interface 30 may also include light emitters, such as light emitting diodes, sound emitters, such as a speaker, and/or haptic actuators to output visual, audio and/or haptic messages (e.g., warnings or alerts) to the vehicle operator. In the case of visual messages, different information can be conveyed through differences in color, differences in intensity, differences in the number of lights, and differences in the pattern of activation of the lights. In the case of audio messages, different information can be conveyed through differences in the type of sound generated, differences in volume and differences in the pattern of sounds. In the case of haptic messages, different information can be conveyed through differences in the length, intensity, or pattern of vibration.

Controller 32 determines whether warnings and/or assistance to the operator of vehicle 10 are required and, when required, generates control signals to provide the warnings and/or assistance. Controller 32 may comprise a programmable microprocessor or microcontroller or may comprise application specific integrated circuits (ASIC). Controller 32 may include a memory and a central processing unit (CPU). Controller 32 may also include an input/output (I/O) interface including a plurality of input/output pins or terminals through which the controller 32 may receive a plurality of input signals and transmit a plurality of output signals. The controller 32 may, for example, receive input signals from sensors 28, operator interface 30, and other systems on vehicle 10 such as brake control system 18. Controller 32 may, for example, transmit output signals to operator interface 30 or other control systems on vehicle 10 such as brake control system 18.

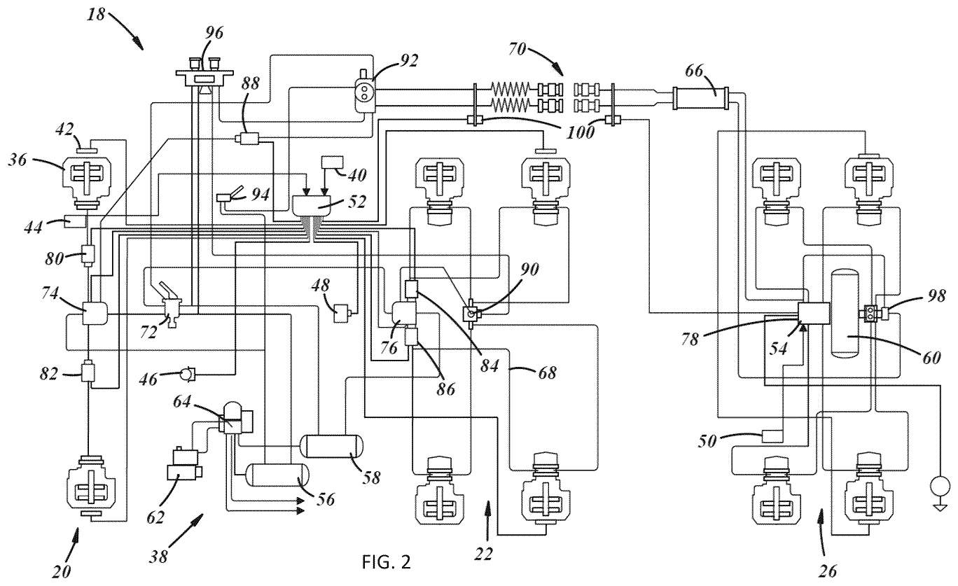

Brake control system 18 is provided to brake wheels 26 on tractor 12 and trailer 14 in order to slow or stop movement of vehicle 10. System 18 may include components on both tractor 12 and trailer 14 that may be in fluid and/or electrical communication using conventional connectors between tractor 12 and trailer 14. In accordance with the systems and methods disclosed herein, brake control system 18 may communicate with ADAS systems 16 over communications bus 34. In particular, brake control system 18 may be configured to brake wheels 24 in response to a braking command generated by controller 32 of ADAS system 16 whenever controller 32 determines that automated emergency braking is required based on signals generated by sensors 28 in ADAS system 16. Referring now to FIG. 2, brake control system 18 may include wheel brakes 36, a fluid circuit 38 that supplies fluid pressure to wheel brakes 36, sensors that identify various conditions associated with vehicle 10 and the surrounding environment and that impact braking of vehicle 10 including vehicle speed sensors such as an engine or transmission speed sensor 40 and wheel speed sensors 42, pressure sensors 44, a steer angle sensor 46, a yaw rate sensor 48, and load sensors 50, and one or more controllers 52, 54.

Wheel brakes 36 are configured to apply a braking force to one or more wheels 24 on vehicle 10. Wheel brakes 36 are located at each end of steer axle 20, drive axles 22 and trailer axles 26. In the illustrated embodiment, wheel brakes 36 comprise disc brakes in which a carrier supports brake pads on opposite sides of a rotor rotating with the wheel 24 and an actuator causes, responsive to fluid pressure delivered by fluid circuit 38, movement of a caliper relative to the carrier to move the brake pads into and out of engagement with the rotor. Alternatively, one or more of wheel brakes 36 may comprise drum brakes in which an actuator such as a cam or piston causes, responsive to fluid pressure delivered by fluid circuit 38, movement of one or more brake shoes into engagement with a braking surface in a brake drum rotating with wheel 24. Wheel brakes 36 may be configured to function as both a service brake for applying service braking while the vehicle is an active state and as a parking brake for applying parking or emergency braking while the vehicle is an active or inactive state. To enable functionality as a service brake, the brake actuator for wheel brake 36 may include a member (e.g., a pushrod connected to a diaphragm) that is moved in one direction responsive to the presence of fluid pressure to move the wheel brake 36 to an applied state and in the opposite direction responsive to the absence of fluid pressure to move the wheel brake 36 to a released state. To enable functionality as a parking brake, the brake actuator for wheel brake 36 may include a spring that biases the wheel brake 36 to an applied state. Fluid pressure provided to the brake actuator is used to overcome the force of the spring and move the wheel brake 36 to a released state.

Fluid circuit 38 generates fluid pressure within brake control system 18 and controls the delivery of fluid pressure to the actuator of each wheel brake 36 to apply or release either or both of a service brake and a parking brake depending on the configuration of the wheel brake 36. Circuit 38 may include components for generating and storing pressurized fluid including fluid sources 56, 58, 60, a compressor 62, and air treatment modules 64, 66 and components for routing and delivering fluid pressure to wheel brakes 36 including fluid conduits 68, glad-hand connectors 70 between tractor 12 and trailer 14, and various devices for controlling the flow of fluid within circuit 38 including a foot brake module 72, electropneumatic valve modules 74, 76, 78, modulator valves 80, 82, 84, 86, 88, a quick release valve 90, a tractor protection valve 92, a trailer control valve 94, a dash control valve 96 and a trailer parking control valve 98.

Fluid sources 56, 58, 60 store compressed fluid for use in applying wheel brakes 36. Fluid sources 56, 58 supply pressurized fluid to the wheel brakes 36 for steer axle 20 and drive axles 22. Fluid source 56 has fluid ports coupled to air treatment module 64, foot brake module 72, electropneumatic valve module 74 and trailer control valve 94. Fluid source 58 has fluid ports coupled to air treatment module 64, foot brake module 72 and electropneumatic valve module 76. Fluid source 60 supplies pressurized fluid to the wheel brakes 36 for trailer axles 26. Fluid source 60 has fluid ports coupled to electropneumatic valve module 78 and trailer parking control valve 98.

Compressor 62 draws in air and compresses the air for delivery to fluid sources 56, 58 through air treatment module 64. Compressor 62 has one or more fluid ports coupled to air treatment module 64.

Air treatment modules 64, 66 are provided to collect and remove solid, liquid and vapor contaminants from pressurized fluid. Air treatment module 64 is disposed between compressor 62 and fluid sources 56, 58 and has fluid ports coupled to compressor 62 and each fluid source 56, 58. Air treatment module 66 is supported on trailer 14 between glad-hand connectors 70 and electropneumatic valve module 78 and has fluid ports coupled to glad-hand connectors 70 and electropneumatic valve module 78. Air treatment module 66 assists in removing contaminants from the fluid in situations where tractor 12 lacks an air treatment module and/or when trailer 14 becomes disconnected from tractor 12.

Fluid conduits 68 are used to transport fluid between fluid sources 56, 58, 60 compressor 62, air treatment modules 64, 66, glad-hand connectors 70, foot brake module 72, electropneumatic valve modules 74, 76, 78, modulator valves 80, 82, 84, 86, 88, quick release valve 90, tractor protection valve 92, trailer control valve 94, dash control valve 96 and trailer parking control valve 98 and wheel brakes 36. Conduits 68 may be made from conventional metals and/or plastics and have connectors at either end configured to join the conduits 68 to corresponding components of circuit 38.

Glad-hand connectors 70 are used to transmit pressurized fluid from tractor 12 to trailer 14. One of connectors 70 is used to transmit supply/emergency fluid pressure during emergency braking while the other connector 70 is used to transmit service/control fluid pressure during service braking.

Foot brake module 72 provides an interface through which a vehicle operator may input a command to apply wheel brakes 36 and control the delivery of fluid pressure to wheel brakes 36 for service braking. Foot brake module 72 is supported within the cabin of tractor 12 and includes a brake pedal that may be actuated by the operator. Actuation of the brake pedal opens a valving member in foot brake module 72 that allows fluid pressure from fluid sources 56, 58 to flow to electropneumatic valve modules 74, 76 and tractor protection valve 92. Foot valve module 52 therefore has fluid ports in communication with fluid sources 56, 58, electropneumatic valve modules 74, 76 and tractor protection valve 92. It should be understood that foot brake module 72 includes one example of an operator-controlled valve for service braking, but that other types of operator-controlled valves for service braking may be used in addition to, or as an alternative to, the valve in foot brake module 72.

Electropneumatic valve modules 74, 76, 78 are provided to control delivery of fluid pressure to wheel brakes 36 on steer axle 20, drive axles 22 and trailer axles 26, respectively, for use in controlling the application and release of service brakes in wheel brakes 36. Module 74 may define a single fluid channel configured to deliver the same fluid pressure to wheel brakes 36 on either end of steer axle 20. Modules 76, 78, may define a pair of fluid channels permitting delivery of varying fluid pressure to the wheel brakes on either end of drive axles 22 and trailer axles 26 for use in stability control. Modules 74, 76, 78 include one or more relay valves that deliver fluid pressure from a fluid source 56, 58, 60 to wheel brakes 36 or exhausts fluid pressure from wheel brakes 36 responsive to a control pressure (from, for example, foot brake module 72). The relay valves increase the volume of fluid, and therefore the flow, at which fluid is delivered to, and exhausted from, wheel brakes 36 in order to reduce lag times between the commanded and actual application and release of wheel brakes 36. Modules 74, 76, 78 further include solenoid valves configured to regulate the control pressure from foot brake module 72 and, therefore, control the operation of the relay valve. An electronic control unit in each module 74, 76, 78 controls the operation of the solenoid valves responsive to control signals from one of controllers 52, 54. The electronic control unit may also process signals from pressure sensors within modules 74, 76, 78 and from wheel speed sensors 42 and brake lining wear sensors associated with corresponding wheels and wheel brakes 36, respectively, and may generate and transmit signals indicative of fluid pressure, wheel speed and brake lining wear to any of controllers 52, 54. Modules 74, 76, 78 may transmit signals to and/or receive signals from controllers 52, 54 indirectly over bus 34 or, alternatively, through dedicated electrical connections with controllers 52, 54. Electropneumatic valve module 74 has fluid ports in communication with food pedal module 72, fluid source 56 and modulator valves 80, 82, 88. Electropneumatic valve module valve 76 has fluid ports in communication with food pedal module 72, fluid source 58, modulator valves 84, 86 and quick release valve 90. Electropneumatic valve module valve 78 has fluid ports in communication with air treatment module 66, trailer parking control valve 98 and each wheel brake 36 on trailer axles 26. Electropneumatic valve module valve 78 may be integrated with a modulator valve and controller 54 in some embodiments. Electropneumatic valve module 74, 76, 78 may operate under the control of controllers 52, 54 to implement anti-lock braking/traction control when required.

Modulator valves 80, 82, 84, 86, 88 are provided to implement an anti-lock braking function. During normal braking, valves 80, 82, 84, 86, 88 allow fluid pressure to pass from electropneumatic valve modules 74, 76 to wheel brakes 36 without interference. During a loss of traction, however, signals from controller 52 causes modulator valves 80, 82, 84, 86, 88 to modulate the fluid pressure to prevent lockup of the wheels 24. Modulator valves 80, 82 have fluid ports coupled to electropneumatic valve module 74 and to wheel brakes 36 on steer axle 20. Modulator valves 84, 86 have fluid ports coupled to electropneumatic valve module 76 and to wheel brakes 36 on drive axle 22. Finally, modulator valve 88 has fluid ports in communication with electropneumatic valve module 74 and tractor protection valve 92.

Quick release valve 90 transmits fluid pressure from dash control valve 96 to the brake actuators for the wheel brakes 36 on drive axles 22 and exhausts fluid from wheel brakes 36 in the absence of fluid pressure from dash control valve 96 to release and apply parking brakes in wheel brakes 36 on drive axles 22. Valve 90 has a supply port in fluid communication with a delivery port on dash control valve 90 and delivery ports in fluid communication with the brake actuators for the wheel brakes 36 on drive axles 22. Valve 90 further has a balance port in fluid communication with electropneumatic valve module 76 to prevent compounding during service braking.

Tractor protection valve 92 transmits pneumatic signals relating to operation of the wheel brakes 36 on trailer 14 from tractor 12 to trailer 14 including control pressures to control the service brakes in wheel brakes 36 of trailer 14. Valve 92 also protects the fluid supply for tractor 12 in the event of a brake in the fluid connection between tractor 12 and trailer 14. Valve 92 has fluid ports in communication with foot pedal module 72, modulator valve 88, trailer control valve 94, dash control valve 96, and glad-hand connectors 70.

Trailer control valve 94 allows the vehicle operator to control wheel brakes 36 on trailer 14 independent of the wheel brakes 36 on tractor 12. Valve 94 may be mounted within the cabin of tractor 12 and permits delivery of fluid directly from fluid source 56 to tractor protection valve 92 for delivery to wheel brakes 36 in trailer 14. Valve 94 has fluid ports in communication with fluid source 56 and tractor protection valve 92.

Dash control valve 96 allows the vehicle operator to implement several functions including releasing parking brakes on tractor 12 or trailer 14 by supplying fluid pressure to oppose spring forces in the actuators for wheel brakes 36. Valve 96 has fluid ports in communication with fluid sources 56, 58, quick release valve 90 and tractor protection valve 92.

Trailer parking control valve 98 is provided to control the parking or emergency braking function of the actuators for the wheel brakes 36 on trailer 14. Valve 98 is mounted directly to fluid source 60. Valve 98 has fluid ports in communication with fluid source 60, air treatment module 66 and wheel brakes 36 on trailer 14.

Engine or transmission speed sensor 40 generates a signal indicative of the speed of vehicle 10. Sensor 40 may comprise one or more magnets configured to track the rotation of a driveshaft or similar component in the drivetrain for tractor 12 and generate signals indicative of the speed of rotation. A controller, such as controller 52 can then determine the speed of vehicle 10 responsive to the signal.

Wheel speed sensors 42 generate signals indicative of the rotational speed of a corresponding wheel 24. Each sensor 42 may include a magnet surrounded by a coil disposed proximate to a toothed ring on a wheel 24. Rotation of the toothed ring causes changes in the direction and intensity of the magnetic fields and is indicative of rotation of the wheel 24. Controllers 52, 54 can determine the rotational speed of each wheel 24 responsive to signals generated by sensors 42. Based on the rotational speed of wheels 24, controllers 52, 54 can determine whether certain wheels 24 are slipping and implement anti-lock braking through control of electropneumatic valve modules 74, 76, 78 and modulator valves 80, 82, 84, 86, 88. Controllers 52, 54 can also determine the speed of vehicle 10 responsive to the determined speed of wheels 24.

Pressure sensors 44 generate signals indicative of the fluid pressure at various locations within fluid circuit 38. Although only one pressure sensor 44 is illustrated in FIG. 2, it should be understood that pressure sensors 44 may be located through fluid circuit 38.

Steer angle sensor 46 outputs a signal indicative of a steering angle imparted by a vehicle operator to a steering wheel in tractor 12. Sensor 46 may be mounted on a steering column within tractor 12.

Yaw rate sensor 48 generates a signal indicative of the angular velocity of tractor 12 about its vertical (yaw) axis. An electronic stability control system may compare the output of sensors 46, 48 to determine whether the intended direction of travel for vehicle 10 (as indicated by sensor 46) matches the actual direction of travel (as indicated by sensor 48) and thereby determine whether there has been a loss of traction between the wheels 24 and the road. When the intended and actual directions of vehicle 10 diverge, the system generates control signals for one or both of the vehicle engine and the wheel brakes 36 in order to control the torque at one or more of the wheels 24 so that the actual direction of vehicle 10 will match the intended direction.

Load sensor 50 generates a signal indicative of the forces at a given location. Load sensor 50 may be used to determine the load on one or more of trailer axles 26 in order to assist in determining the stability of trailer 14. Load sensor 50 may comprise a strain gauge, piezoelectric sensor or a fluid (hydraulic or pneumatic) sensor.

Controllers 52, 54 control the operation of electropneumatic valve modules 74, 76, 78 and modulator valves 80, 82, 84, 86, 88 in order to control the fluid pressure delivered to wheel brakes 36 and, therefore, the braking force applied to wheels 24. Controllers 52, 54 may comprise programmable microprocessors or microcontrollers or may comprise application specific integrated circuits (ASICs). Each controller 52, 54 may include a memory and a central processing unit (CPU). Each controller 52, 54 may also include an input/output (I/O) interface including a plurality of input/output pins or terminals through which the controller 52, 54 may receive a plurality of input signals and transmit a plurality of output signals. The input signals may include signals received from controller 32 in ADAS system 16 and from sensors 40, 42, 44, 46, 48, 50. The output signals may include signals used to control electropneumatic valve modules 74, 76, 78 and modulator valves 80, 82, 84, 86, 88. In the illustrated embodiment, tractor 12 and trailer 14 include separate controllers 52, 54 that may communicate with one another across an electrical connector 100 between tractor 12 and trailer 14. It should be understood, however, that the functionality of controllers 52, 54 could be combined into a single controller or further sub-divided among multiple sub-controllers. In accordance with the present teachings, one or both of controllers 52, 54 may be configured with appropriate programming instructions (i.e., software or a computer program) to implement several steps in a method for controlling service braking in trailer 14 as described below. The instructions or computer program may be encoded on a non-transitory computer storage medium such as a memory within, or accessible by, controllers 52, 54.

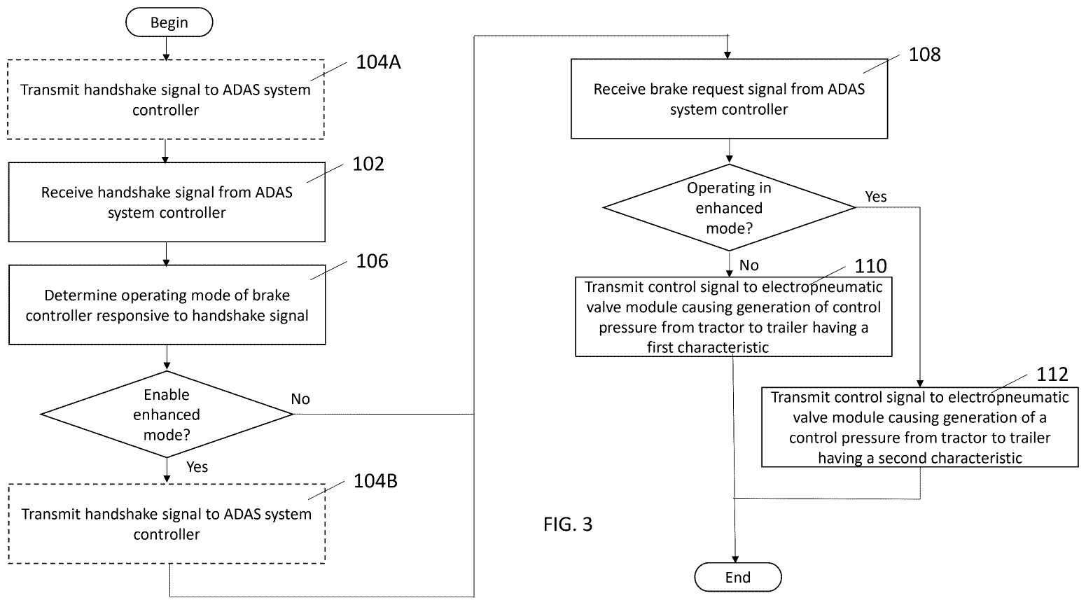

Referring now to FIG. 3, the method may begin with the step 102 of receiving a handshake signal generated by, and transmitted by, controller 32 of ADAS system 16. In accordance with one aspect of the systems and methods disclosed herein, controllers 52, 54 may be configured to operate in a basic mode of operation in which, for example, controller 52 causes transmission of a control pressure from tractor 12 to trailer 14 having a relatively low fluid pressure or a duty cycle in which fluid pressure is provided for a relatively short time (e.g., a pulsed fluid pressure) to reduce the likelihood that wheel brakes 36 on trailer 14 will lock and an enhanced mode of operations in which, for example, controller 52 causes transmission of a control pressure from tractor 12 to trailer 14 having a relatively high fluid pressure or a duty cycle in which fluid pressure is provided for a relatively long time to enable an increase in braking torque from the wheel brakes 36 on trailer 14 and a reduction in stopping distance for vehicle 10. Similarly, controller 32 for ADAS system 16 may be configured to operate in a basic mode and an enhanced mode in which the functionality of ADAS system 16 is varied. For example, ADAS system 16 may generate brake request signals at different times or in response to different thresholds while operating in basic mode and while operating in enhanced mode. In one embodiment, ADAS system 16 generates brake request signals relatively early in time while in basic mode and relatively late in time while in enhanced mode. In particular, if ADAS system 16 is operating in enhanced mode, ADAS system 16 may generate brake request signals later in time—knowing that controllers 52, 54 are also operating in enhanced mode and, therefore, that brake control system 18 is capable of greater deceleration and the stopping distance for vehicle 10 is reduced relative to when controllers 52, 54 are operating in basic mode. If ADAS system 16 is operating in basic mode, ADAS system 16 may generate brake request signals earlier in time—knowing that controllers 52, 54 are also operating in basic mode and, therefore, that brake control system 18 is only capable of lesser deceleration and the stopping distance for vehicle 10 is increased relative to when controllers 52, 54 are operating in enhanced mode. The mode of operation for each of controllers 32, 52, 54 is determined responsive to handshake signals exchanged between controllers 32, 52, 54 (in the absence of any handshake signals, the controllers 32, 52, 54 operate in basic modes of operation). The handshake signals may include identification data from which controllers 52, 54 can identify and authenticate an ADAS system 16 on vehicle 10 that is permitted to cause activation of the enhanced mode of operation in brake control system 18 and/or from which controller 32 for ADAS system 16 can identify and authenticate a brake control system 18 on vehicle 10 allowing ADAS system 16 to implement an enhanced mode of operation. The identification data may, for example, include an identifier associated with controller 32 of ADAS system 16 and/or controllers 52, 54 of braking system 18, a software version number software executed by controller 32 of ADAS system 16 and/or controllers 52, 54 of braking system 18, an identifier associated with an owner of vehicle 10 or a public key known by controller 32 of ADAS system 16 and controllers 52, 54 of brake control system 18, or a checksum value verifiable by only controller 32 of ADAS system 16 and controllers 52, 54 of brake control system 18 (e.g., an addition of the value of each byte of information in the message encoded in the signal, a value known only to the controllers 32, 52, 54, and a counter value). Generation of an initial handshake signal from controller 32 of ADAS system 16 and/or from controllers 52, 54 of brake control system 18 may be triggered in response to activation of vehicle 10 (e.g., based on signals indicative of the activation of vehicle 10 such as signals generated by current or voltage sensors indicating delivery of power from the vehicle battery or signals generated by position sensors indicating the position of a key or start button). Alternatively, generation of the initial handshake signal may be triggered in response to other conditions associated with the operation of vehicle 10 such as the speed of vehicle 10 (as indicated by engine or transmission speed sensor 40 or wheel speed sensor 42) reaching a predetermined speed. In yet another alternative, generation of the initial handshake signal may be triggered in response to an inquiry signal transmitted by controller 32 of ADAS system 16 or controllers 52, 54 of brake control system 18. In particular, controller 32 of ADAS system 16 may generate an inquiry signal on communications bus 34 requesting transmission of an initial handshake signal from controllers 52, 54 of brake control system 18 or controllers 52, 54 of brake control system 18 may generate an inquiry signal on communications bus 34 requesting transmission of an initial handshake signal from controller 32 of ADAS system 16. Because controller 32 of ADAS system 16 or brake controllers 52, 54 of brake control system 18 may generate the initial handshake signal, in some embodiments brake controllers 52, 54 may, as indicated in step 104A, transmit the initial handshake signal to controller 32 of ADAS system 16 prior to receiving a return handshake signal from controller 32 of ADAS system 16 in step 102 while in other embodiments controllers 52, 54 of brake control system 18 may, as indicated in step 104B, transmit a return handshake signal to controller 32 of ADAS system 16 after receiving the initial handshake signal from controller 32 of ADAS system 16 and authenticating the handshake signal received from controller 32 of ADAS system 16 as described hereinbelow.

The method may continue with the step 106 of determining, responsive to the handshake signal from controller 32 of ADAS system 16, whether the controllers, 52, 54 will operate in the basic mode or the enhanced mode. In embodiments in which the initial handshake signal is transmitted from controller 32 of ADAS system 16 to controllers 52, 54 of brake control system 18 (i.e., without step 104A), step 106 may include a comparison of identification data obtained from the handshake signal received from controller 32 of ADAS system 16 to acceptable identification data in a memory accessible by controllers 52, 54. The memory may be internal to controllers 52, 54 or external to controllers 52, 54 and accessed through, for example, communications bus 34. Controllers 52, 54 may be configured to determine that controllers 52, 54 will operate in the enhanced mode if the identification data in the handshake signal is equal to the acceptable identification data. Alternatively, controllers 52, 54 may be configured to determine that controllers 52, 54 will operate in the enhanced mode if a portion of the identification data in the handshake signal is equal to a portion of the acceptable identification data or if the identification data in the handshake signal meets a threshold relative to the acceptable identification data (e.g., the software version in the identification data of the handshake signal is later than the software version in the acceptable identification data). If controllers 52, 54 determine that controllers 52, 54 will operate in the enhanced mode, controllers 52, 54 may transmit a return handshake signal to controller 32 of ADAS system 16 in step 104B to acknowledge the initial handshake signal from controller 32 of ADAS system 16 and confirm that brake controllers 52, 54 will operate in the enhanced mode. Controller 32 of ADAS system 16 may be configured to determine, responsive to this return handshake signal, that controller 32 of ADAS system 16 will also operate in an enhanced mode. In particular, the return handshake signal may also include identification data and controller 32 of ADAS system 16 may compare the identification data in the second handshake signal to acceptable identification data in a memory accessible by controller 32. Alternatively, because controllers 52, 54 of brake control system 18 have already performed the authentication action, the return handshake signal may omit similar identification data and/or controller 32 of ADAS system 16 may simply rely on receipt of the return handshake signal to determine that controller 32 will operate in an enhanced mode.

In embodiments in which the first handshake signal is transmitted from controllers 52, 54 of brake control system 18 to controller 32 of ADAS system 16 (i.e., including step 104A), controller 32 of ADAS system 16 may determine whether controller 32 of ADAS system 16 will operate in a basic mode or enhanced mode in a similar manner to that described hereinabove. In particular, controller 32 of ADAS system 16 may compare identification data obtained from the initial handshake signal received from controllers 52, 54 of brake control system 18 to acceptable identification data in a memory accessible by controller 32. The memory may be internal to controller 32 or external to controller 32 and accessed through, for example, communications bus 34. If controller 32 determines that controller 32 will operate in the enhanced mode, controller 32 may transmit a return handshake signal to controllers 52, 54 of brake control system 18 in step 102 to acknowledge the initial handshake signal from controllers 52, 54 of brake control system 18 and confirm that controller 32 will operate in the enhanced mode. Because controller 32 of ADAS system 16 has already performed the authentication action, the second handshake signal may omit similar identification data and controllers 52, 54 of brake control system 18 may, in step 106, simply determine that controllers 52, 54 will operate in an enhanced mode based on receipt of the return handshake signal from controller 32 of ADAS system 16.

The method may continue with the step 108 of receiving a brake request signal from controller 32 of ADAS system 16. The brake request signal is a request from ADAS system 16 to implement service braking of the wheel brakes 36 on vehicle 10. If it was determined in step 106 that controllers 52, 54 are operating in a basic mode, the method may continue with the step 110 of transmitting a first control signal from controller 52 to an electropneumatic valve module 74 in response to the brake request signal. The first control signal is configured cause electropneumatic valve module 74 to deliver a control pressure (through tractor protection valve 92 and gladhand connector 70) with a first characteristic. In one embodiment, the first characteristic may be that the control pressure is relatively low. In another embodiment, the first characteristic may be that the duty cycle for the control pressure has a relatively short “on” period during which fluid pressure is delivered. If it was determined in step 104 that controllers 52, 54 are operating in an enhanced mode, the method may continue with the step 112 of transmitting a second control signal from controller 52 to electropneumatic valve module 74 in response to the brake request signal. The second control signal is configured to cause electropneumatic valve module 74 to deliver a control pressure (through tractor protection valve 92 and gladhand connector 70) with a second characteristic, different than the first characteristic. In one embodiment, the second characteristic may be that the control pressure is relatively high. In another embodiment, the second characteristic may be that the duty cycle for the control pressure has a relatively long “on” period during which fluid pressure is delivered. In either case, the control pressure with the second characteristic will allow wheel brakes 36 on trailer 14 to apply a greater braking torque and reduce the stopping distance of vehicle 10.

A system and method for controlling service braking in a trailer 14 of a combination vehicle 10 in accordance with the teachings disclosed herein is advantageous relative to conventional systems and methods. In particular, the disclosed systems and method allow variation in the control pressure used for trailer service braking based on the identity of the system requesting actuation of the service brakes thereby allowing selective delivery of greater control pressures and, as a result, increased service braking torque from the trailer service brakes and a reduction in the stopping distance for the vehicle 10.

While the invention has been shown and described with reference to one or more particular embodiments thereof, it will be understood by those of skill in the art that various changes and modifications can be made without departing from the spirit and scope of the invention.

What is claimed is:

1. A system for controlling service braking in a trailer of a combination vehicle, comprising:
an electropneumatic valve module having a supply port in fluid communication with a fluid source and a delivery port configured to deliver a control pressure to the trailer for actuating a service brake on the trailer;
a brake controller configured to operate in a basic mode and an enhanced mode, the brake controller configured to
receive a first handshake signal from an advance driver assistance system (ADAS) controller on the combination vehicle;
determine, responsive to the first handshake signal, whether the brake controller will operate in the basic mode or the enhanced mode;
receive a brake request signal from the ADAS controller;
transmit, if the brake controller is operating in the basic mode, a first control signal to the electropneumatic valve module in response to the brake request signal, the first control signal configured cause the electropneumatic valve module to deliver the control pressure with a first characteristic; and,
transmit, if the brake controller is operating in the enhanced mode, a second control signal to the electropneumatic valve module in response to the brake request signal, the second control signal configured to cause the electropneumatic valve module to deliver the control pressure with a second characteristic different than the first characteristic.

2. The system of claim 1 wherein the first handshake signal includes identification data and the brake controller is further configured to determine whether the brake controller will operate in the basic mode or the enhanced mode responsive to the identification data.

3. The system of claim 2 wherein the identification data comprises at least one of an identifier associated with the ADAS controller, a version number of software executed by the ADAS controller, an identifier associated with an owner of the vehicle, and a public key common to the brake controller and the ADAS controller.

4. The system of claim 2 wherein the brake controller is further configured, in determining whether the brake controller will operate in the basic mode or the enhanced mode responsive to the identification data, to compare the identification data to acceptable identification data in a memory accessible by the brake controller.

5. The system of claim 1 wherein the brake controller is further configured to transmit a second handshake signal to the ADAS controller and the ADAS controller is configured to determine, responsive to the second handshake signal, whether the ADAS controller will operate in a basic mode or an enhanced mode.

6. The system of claim 5 wherein the second handshake signal includes identification data and the ADAS controller is further configured to determine whether the ADAS controller will operate in the basic mode of the ADAS controller or the enhanced mode of the ADAS controller responsive to the identification data.

7. An article of manufacture, comprising:
a non-transitory computer storage medium having a computer program encoded thereon that, when executed by a brake controller for a braking system of a combination vehicle controls service braking in a trailer of the combination vehicle, the vehicle including an electropneumatic valve module having a supply port in fluid communication with a fluid source and a delivery port configured to deliver a control pressure to the trailer for actuating a service brake on the trailer and the brake controller configured to operate in a basic mode and an enhanced mode, the computer program including code for:
determining, responsive to a first handshake signal received by the brake controller from an advance driver assistance system (ADAS) controller on the combination vehicle, whether the brake controller will operate in the basic mode or the enhanced mode;
recognizing a brake request signal received by the brake controller from the ADAS controller;
causing the brake controller to transmit, if the brake controller is operating in the basic mode, a first control signal to the electropneumatic valve module in response to the brake request signal, the first control signal configured cause the electropneumatic valve module to deliver the control pressure with a first characteristic; and,
causing the brake controller to transmit, if the brake controller is operating in the enhanced mode, a second control signal to the electropneumatic valve module in response to the brake request signal, the second control signal configured to cause the electropneumatic valve module to deliver the control pressure with a second characteristic different than the first characteristic.

8. The article of manufacture of claim 7 wherein the first handshake signal includes identification data and the computer program further includes code for determining whether the brake controller will operate in the basic mode or the enhanced mode responsive to the identification data.

9. The article of manufacture of claim 8 wherein the identification data comprises at least one of an identifier associated with the ADAS controller, a version number of software executed by the ADAS controller, an identifier associated with an owner of the vehicle, and a public key common to the brake controller and ADAS controller.

10. The article of manufacture of claim 8 wherein the code for determining whether the brake controller will operate in the basic mode or the enhanced mode responsive to the identification data includes code for comparing the identification data to acceptable identification data in a memory accessible by the brake controller.

11. The article of manufacture of claim 7 wherein the computer program further include code for causing the brake controller to transmit a second handshake signal to the ADAS controller and the ADAS controller is configured to determine, responsive to the second handshake signal, whether the ADAS controller will operate in a basic mode or an enhanced mode.

12. The article of manufacture of claim 11 wherein the second handshake signal includes identification data and the ADAS controller is further configured to determine whether the ADAS controller will operate in the basic mode of the ADAS controller or the enhanced mode of the ADAS controller responsive to the identification data.

13. A method for controlling service braking in a trailer of a combination vehicle, the vehicle including an electropneumatic valve module having a supply port in fluid communication with a fluid source and a delivery port configured to deliver a control pressure to the trailer for actuating a service brake on the trailer, the method comprising:
receiving, at a brake controller on the combination vehicle, a first handshake signal from an advance driver assistance system (ADAS) controller on the combination vehicle;
determining, responsive to the first handshake signal, whether the brake controller will operate in a basic mode or an enhanced mode;
receiving, at the brake controller, a brake request signal from the ADAS controller;
transmitting, if the brake controller is operating in the basic mode, a first control signal to the electropneumatic valve module in response to the brake request signal, the first control signal configured cause the electropneumatic valve module to deliver the control pressure with a first characteristic;
transmitting, if the brake controller is operating in the enhanced mode, a second control signal to the electropneumatic valve module in response to the brake request signal, the second control signal configured to cause the electropneumatic valve module to deliver the control pressure with a second characteristic different than the first characteristic.

14. The method of claim 11 wherein the first handshake signal includes identification data and the method further includes determining whether the brake controller will operate in the basic mode or the enhanced mode responsive to the identification data.

15. The method of claim 11 wherein the identification data comprises at least one of an identifier associated with the ADAS controller, a version number of software executed by the ADAS controller, an identifier associated with an owner of the vehicle, and a public key common to the brake controller and the ADAS controller.

16. The method of claim 11 wherein determining whether the brake controller will operate in the basic mode or the enhanced mode responsive to the identification data includes comparing the identification data to acceptable identification data in a memory accessible by the brake controller.

17. The method of claim 11, further comprising transmitting a second handshake signal to the ADAS controller, the ADAS controller is configured to determine, responsive to the second handshake signal, whether the ADAS controller will operate in a basic mode or an enhanced mode.

18. The method of claim 17 wherein the second handshake signal includes identification data and the ADAS controller is further configured to determine whether the ADAS controller will operate in the basic mode of the ADAS controller or the enhanced mode of the ADAS controller responsive to the identification data.
